(19) United States
(12) Patent Application Publication
(10) Pub. No.: US 2014/0372188 A1
(43) Pub. Date: Dec. 18, 2014

(54) LOOPED INCENTIVE COMMERCE SYSTEM

(71) Applicant: Robert Desideri, Palm Beach, FL (US)

(72) Inventor: Robert Desideri, Palm Beach, FL (US)

(21) Appl. No.: 13/916,158

(22) Filed: Jun. 12, 2013

(51) Int. Cl. G06Q 30/02

(52) U.S. Cl. CPC G06Q 30/0214; G06Q 40/04
USPC 705/14.16

(57) ABSTRACT

A native virtual currency is awarded to parties of the system, for example potential customers of commercial parties, for use in commerce. The awarding entity, the system, itself accepts native virtual currency toward payment for system services provided to members, for example advertising a party's willingness to accept a native virtual currency in transactions and other commerce related services.

### BACKGROUND

The present invention generally relates to electronic commerce.

It has proven difficult for advertisers to exploit the Internet for acquiring new customers and convert electronic advertising into sales. This is true both for the more traditional online display advertising as seen on web pages and, more recently, advertising schemes on mobile devices such as smart phones or other mobile media where publishers presently squeeze in ads amongst editorial content displayed on tiny screens. The principal reason for such advertisers' difficulties, it would appear, is that the much of the advertising on the Internet is not much more than an electronic incarnation of print advertising, sometimes supplemented with video. Advertisers generally perceive that the response rate to online ads, and particularly ads presented on mobile devices, is too low, resulting in downward pressure for on online ad pricing to the chagrin of publishers. Sluggish economic conditions may also contribute to consumer reluctance to spend, particularly for the underemployed and unemployed. The confluence of ineffective advertising and slow economic periods puts further downward pressure on ad as well as on goods and services. Product discounting generally hurts bottom lines for both publishers and advertisers.

Online, virtual currencies have been utilized for many years in games, fantasy worlds, retail promotions, loyalty schemes, earning schemes, promotions and elsewhere. Most frequently virtual currency is purchased or received with a purchase, for example virtual coin spending and flyer miles. Virtual currency is sometimes given away in promotions, and as with most free samples, the expectation is for the recipient to develop a taste and come back for more—but perhaps not free again after the first taste.

### SUMMARY OF THE INVENTION

The present invention is directed at least in part to overcoming the above and other problems in the area of commerce in general, both online and in the physical world.

The invention, a looped incentive commerce system, is carried out by an electronic system that encourages transactions by and among particular electronic transactors, referred to herein as “member transactors”, “users” and “members”. Members may be sellers as well as buyers, also givers or receivers of gratuities. Member transactors transact via the system using “native virtual currency.” “Native virtual currency” as used herein means virtual currency or other value whose use is limited by the system to transactions with and among the member transactors. The systems inventive methods for circulating native virtual currency stimulate commerce, benefiting member transactors.

The system “seeds” some or all members with a valuable asset—a virtual currency—that may be utilized, in the system, for members to make purchases, gifts, exchanges and otherwise perform commerce.

One could think of seeds, amounts of one or more native virtual currencies, as a means to enjoy “discounts”. For example, an item that has an “everyday price” at a vendor, for example a pint of premium gelato, of US$9.99 could be purchased for US$7.99 in cases where the vendor is willing to accept native virtual currency, perhaps in this example one unit, plus US$7.99 rendered by the customer instead of the US$9.99 everyday price. The effective discount is provided to the customer, and interestingly due to the invention's novelty, the vendor has gained one unit of the native virtual currency, which she in turn could use in a further purchase with a further vendor willing to discount a good or service. Or could use it to purchase advertising from the system, for example. The “discount” leaves the vendor with value, an improvement relative to a “traditional” discount.

Let's turn now to how the native virtual currency is awarded and distributed by and from the system to members. Critically, it is not being “purchased” by the members, which means it is not being sold by the system. And it's not being purchased by an advertiser. Said another way, when members receive a distribution of native virtual currency from the system they do not pay for it and advertisers do not pay for it. A distribution is quite different from virtual native currency received in a transaction using the system. And totally different from, for example in internet games and virtual fantasy worlds, how their users purchase tokens, points and other such virtual currencies for use in purchasing virtual goods, for example virtual farm animals and virtual little black dresses from virtual designers. To be crystalline, a native virtual currency distribution to a member from the system is not performed in exchange for a fiat money or non-native virtual currency from the member. Fiat money herein means legal tender that derives its value from government regulation or law, for example United States dollars, Euros, Yen and other such governmental currencies. Fiat money herein may also be referred to sometimes as “real money”. An example of a non-native virtual currency would be Bitcoin or virtual currencies issued by private parties for use in, for example, online games or gaming, or points or flyer miles. A distribution herein means native virtual currency credited to a member as the result of an awarding based upon a criterion. Members of the system may perceive distributions as a reward, when “reward” is used herein it is equated to a distribution.

A native virtual currency distribution occurrence requires satisfaction of at least one award criterion or award “trigger”. The details of the specific criterion may or may not be learned by the receiving or other members prior to or post a distribution. Perceiving receiving an amount of native virtual currency as a reward is beneficial for helping encourage members to be active, which in itself may further result in stimulating commerce. Award triggering is the subject matter of my co-pending patent entitled “Electronic Reward System”. Moreover, the distributing of native virtual currency is explained further in the detailed description section, claims and drawings herein.

Another way to think about distributions of amounts of native virtual currency is as dosages of a “sweet lubricant” for the wheels of commerce, one that solves problems inherent in the prior art, for example couponing, special sale events, loyalty card schemes, Internet display advertisements, Internet click-type rewards, vendor sold redemption scheme tokens, flyer miles, points, stamps, group buying schemes and other such art. These have real money costs to advertisers. These are bothersome to customers and prospects and or they feel like they are being gamed or conned by advertisers. These are left over from earlier days, today appearing on web pages instead of magazine pages.

Principal among the members are a) advertisers—meaning parties with goods, new or old, or services to sell, in simple transactions, auctions or otherwise, who use the looped incentive commerce system as a vehicle for either electronically distributing advertising for those products and/or services or at least for making at least other members aware that the parties will accept the native virtual currency, and b) consumers (also sometimes referred to herein as “patrons”, “purchasers” and “customers”)—meaning potential customers and/or clients for the advertisers. Accordingly, for purposes of simplifying the narrative at this point, this discussion will proceed by describing the system with reference to those parties. It should be appreciated, however, that the description herein is also applicable to any member transactors as defined hereinabove.

Native virtual currency may be stored, for example, in a ‘virtual’ wallet—a program or service maintained in a consumer's computer or smartphone. Or it may be stored in a virtual wallet or other type of account in a “cloud” rather than held in a file on a smartphone that could be lost or stolen, cloud meaning, generally, a data center or service accessible via a network. A “cold” wallet, one that disconnects from the network may also be utilized for storing native virtual currency. Cold wallets are, for example, removable USB memory devices (e.g. flash sticks), DVDs and other such medium, media that may be disconnected or removed from a network. What determines whether storage is hot or cold or on the smartphone or in the cloud is the bookkeeping scheme a system utilizes. The system is agnostic as to the bookkeeping scheme and architecture, the system may be built and operated by persons skilled in the art utilizing any appropriate bookkeeping architecture.

A virtual wallet handling native virtual currency may also handle other virtual currency or real money that is not native virtual currency, for example United States dollars. By handling multiple types of currencies purchases comprising a mix of payment types may be completed seamlessly without having to resort to multiple clearing steps for a mixed currency transaction. For example, purchasing an iced mocha skim latte from a vendor member could require payment of US$4.00—or at the whim of the customer member and vendor—US$2.00 plus 5.00 units of a native virtual currency. For purposes of simplifying the language in examples and descriptions herein we will refer to one particular native virtual currency by a made up moniker—Greenleafs. Deciding on the mixed payment method for the latte, the purchaser's virtual wallet authorizes (this is a highly simplified articulation of the accounting for the purpose of not causing confusion, those skilled in the art will recognize how checking account and credit cards clearing occurs in fine detail) debiting her checking account for US$2.00 (or charging one of her credit cards if that is her preference) and debiting her native virtual currency account, a bookkeeping service performed by the system of the invention, for 5.00 Greenleafs whilst crediting the vendors merchant's checking account for US$2.00 and crediting the merchant's native virtual currency account, again performed by the system's bookkeeping service, with 5.00 Greenleafs. Nothing prevents the transaction from being split and cleared separately, for example the patron handing over to the vendor US$2.00 in cash clearing the real money portion in person and clearing the 5.00 Greenleafs to the vendor via a wallet transaction.

To reiterate, the invention distributes native virtual currency to members to be used in transactions, for example purchase and sale transactions and gifting transactions. All or part of the purchase price goods and services may be “discounted” by any seller member who desires to do so, said discount can be thought of as being “paid for” in an amount of native virtual currency. Or in other words, an amount of native virtual currency has a value to both the seller and the purchaser. When parties of proposed transaction each perceive the value is fair a transaction's completion is more likely. In the latte example, above, it appears that the parties of the transaction agreed that the US$2.00 “real money” discount was equivalent to 8.50 Greenleafs.

Financial viability for the system requires attracting a sufficient number of advertisers. To this end, and in accordance with an important aspect of the invention, the looped incentive commerce system accepts payments in native virtual currency from the advertisers (and potentially other members), in full or partial payment for the services the system provides, thereby effectively providing a “discount” incentive for consuming advertising services, and potentially other services. It is thus seen that the looped incentive commerce system is like a circuit conducting native virtual currency.

Another way to visualize or understand the system of the invention is as a real money currency pump. In distributing native virtual currency to members the system “primes” the pump, the native virtual currency is then able to circulate amongst users in transactions, circulating along side real money in transactions where said native virtual currency is used to discount, pay in part, for goods or services.

Understanding the pump aspect of the system helps visualize how enabling native virtual currency to circulate promulgates commerce, useful both online and in physical stores. Such commerce is beneficial not only the transacting parties but also, for example, nations. When a first portion of a transaction payment is satisfied in native virtual currency, and a second portion is satisfied in a fiat currency, for example, United States dollars, the invention is stimulating the United States economy. Transaction that might not have otherwise occurred may now clear the market, users who may not have had sufficient United States dollars in their checking accounts are enabled by the invention purchases that were otherwise out of their reach.

It is anticipated that the principal way in which the advertisers will come into possession of the native virtual currency is by accepting it from consumers in full or partial payment for goods or services sold by the advertiser. Of course members who receive native virtual currency distributions directly from the system may also utilize such awards for paying the system for its services, for example purchasing an advertisement.

Advertising may include presenting to a member an advertiser's advertisement during, before or transacting, at or around the time of a native virtual currency distribution or in conjunction with such distribution, or in a catalogue of advertisements. For example, a member residing in Brazil receives a distribution of native virtual currency, an advertisement is also presented for a “bargain” offered by a vendor for an electric espresso machine. Herein a “bargain” means and offering. Such a bargain may disclose the vendors willingness to accept an amount of native virtual currency plus an amount of Brazilian Real (Real is the legal tender of Brazil), the advertised bargain further comprising a link to a web page where the member can secure the bargain online and or learn the street address of the vendor's appliance store to make a visit.

It is anticipated that the system may make available a virtual catalogue of offerings of advertisers and or parties who accept native virtual currency payments for goods and services are accepted received by a party on behalf of advertisers. One example of a catalogue of advertisements may be listings of bargains within the “discovery tab” of a virtual wallet or, in a further example in a smart phone application for finding great deals. Advertising need not include specifically a bargain, it could for example include enabling a member to be aware of another member or something as simple as distributing a message on behalf of a member. An example of a message might be delivering to one or more members or non-members via a website, smart phone application or other display method, including print, a message such as “I'm selling my ABC camera, any takers?” or “I had chocolate chip banana pancakes for breakfast” or “I just donated US$10.00 to XYZ charity”. An advertisement could also be for a job offering or simply be an announcement.

Consumer-to-consumer transactions, another way to look at member-to-member transactions, are also possible, such as when, for example, a member sells a bicycle at auction or via online listing to another member. Advantageous to members, it may be easier to locate parties willing to surrender native virtual currency for a good no longer needed, an example being selling a old car by posting a for-sale sign in the car's side window with the sellers email address. Accepting native virtual currency instead of real money in this example, again let's assume Brazilian Real, the seller may have an easier time finding a buyer. After the transaction completes, the seller having native virtual currency, thanks to the system enabling such transactions, and perhaps thanks in part to the buyer receiving one or more distributions of virtual native currency previously, or perhaps the buyer having sold to another party 10 dog walk sessions for native virtual currency, the seller may be able to purchase an espresso machine.

It is also anticipated that the system-to-consumer-to-advertisers-to-system loop will evolve to include advertiser-to-advertiser transactions, for example vendors receiving native virtual currency then subsequently paying suppliers with native virtual currency. For example, a gelato shop receiving native virtual currency from its customers might pay its milk supplier, who is also a system member, in full or in part in native virtual currency. (The milk supplier might or might not be a looped incentive commerce system advertiser.)

Also anticipated is that the system could promulgate commerce for members is further ways than just advertising, for example, providing business services such as internet hosting, communications services, data and analytics services, domain name services, financial and related services and authentication services, accepting payment in full or in part in native virtual currency for any or all services, perhaps goods, property and more, that relate to its commerce promulgation aspect.

As an aspect of its overall operation the system may provide system members with the ability to learn of the membership of other members.

There are incentives “all around” for parties to be members and to participate. Specifically, the system distributes to members native virtual currency spendable for goods and services. Advertisers can perform branding and or secure new customers by virtue of the advertisers' willingness to accept the native virtual currency in full or partial payment for those goods or services. And although doing so might mean receiving less “real” money (fiat money) when a sale is made than would otherwise be the case, the advertiser can still make more money than otherwise. Specifically, as with any incentive or coupon scheme, the advertiser who sells goods or services at less than full price makes more money in the long term by securing new customers and/or by selling additional goods or services to the consumer when s/he comes into a store to use the virtual money.

Unlike traditional couponing schemes, however, advertisers are further benefitted themselves by being able to utilize received native virtual currency, namely being able to purchase commerce services such as advertising from the system in exchange for native virtual currency they themselves have taken in transacting with other members. The system reabsorbing native virtual currency in this manner is an important aspect of the invention.

The invention benefits a looped incentive commerce system operator because the benefits that are provided to the advertisers as outlined above provide an incentive for the advertisers to spend actual currency—for example United States dollars—for or towards services of the system. Although the looped incentive commerce system has thus sold its own services for perhaps less than “full price” by also accepting native virtual currency, at least some of the advertising revenues that it receives will have come from advertisers who would not have become customers but for the advertiser benefits as outlined above.

A further way in which the looped incentive commerce system can make money is to charge a transaction fee on some or all native virtual currency transactions. Another is by charging wallet operators, who it may also be compensated by the system for specific acts, balanced correctly encourages wallet operators to utilize the system for it's customers, to whom it may sell its wallet app or earn income via other methods. A wallet operator, processing-related party, relationship is an aspect of the invention that may help increase adoption of the system as well as may be a further way for the system to make money.

Importantly, the looped incentive commerce system does not bind a native virtual currency with a specific advertiser, any member party willing to accept a specific native virtual currency may do so. This benefits holders of native virtual currency in that they are not ‘stuck’ using it for transactions tied to a particular vendor, for example, a particular airline or consortium of airlines as is the typical case often with flyer miles and travel vouchers.

Advantageously, members may seek to use native virtual currency in transaction with parties who are not members of the system. Since native virtual currency may only be used in transactions with member transactors such behavior by a member encourages non-members to enroll in the system as members to compete for sales. For example, a party relocates his household to an adjacent district where the local dry cleaning service is not yet a member transactor. The party shows the naïve dry cleaner how his previous dry cleaner both attracts new business relationships utilizing the system's advertising and maintains loyalty utilizing the looped incentive commerce system whilst collecting native virtual currency itself for purchasing system advertising and perhaps services from other member transactors. In scenarios where enrollment of a member transactor is accomplished instantaneously electronically the value to a potential patron can help spread system membership whilst quickly benefitting a new member, clearly preferable to a potential new member than merely offering a discount to the new dry cleaning customer relationship. Purchasers want vendors to accept native virtual currency. Vendors don't want to provide discounts, discounts leave vendors empty-handed for the discount amount.

An aspect of the invention that benefits parties of transactions is that the per unit native virtual currency “valuation” is variable, giving users control of pricing. Users are not required to adhere to a mandated cross currency equivalent value for native virtual currency in transactions. If both parties believe they are getting a fair deal probably a transaction will occur. For example, a first pub in Spain may allow it's clients to pay for a beer that normally sells for 6.00 Euros to also transact for said beer by exchanging 1.00 Euro and 5.00 units of a native virtual currency. A second pub across the road may also sell the same exact beer as the first pub for 6.00 Euros and permit its clients to transact for a beer exchanging 1.00 Euro and 4.00 units of the same native virtual currency accepted in the first pub. Ceteris paribus, the second pub may have an overall higher sales volume.

The promulgation of commerce for advertisers; the receipt and surrendering of the native virtual currency; and the bookkeeping associated with all of that as well as the other aspects of the system as described above, are all carried out in large part by computers and mobile devices communicating electronically via data networks such as the web and mobile or various other data networks.

The detection of activity and the detection of proximity; the awarding of a virtual currency; and the awarding associated with all of that as well as the other aspects of the system as described above, are all carried out in large part by computers and mobile devices communicating electronically via the web and mobile or various other communications networks.

The use of the system to distribute the native virtual currency may advantageously be carried out in conjunction with a system of the type disclosed in my co-pending patent application filed of even date herewith, Ser. No. ______ and entitled “Electronic Reward System,” as way of inducing/encouraging consumers to transact within the system.

The details of one or more implementations of the invention are set forth in the accompanying drawings and the description below. Other features, objects, and advantages of the invention will be apparent from the description and drawings, and from the claims.

### BRIEF DESCRIPTION OF THE DRAWINGS

A more complete understanding of the invention may be derived by referring to the detailed description and claims when considering in connection with the Figures, wherein like reference numbers refer to similar elements throughout the Figures, and

FIG. 1 shows a conceptual simplified diagram of the invention's loop;

FIG. 2 shows a conceptual arrangement embodying the principles of the invention;

FIG. 3 is a reward distribution example for a single user;

FIG. 4 is a simplified example of reward-determining data;

FIG. 5 depicts a wallet conceptual illustration;

FIG. 6 depicts an advertisements conceptual illustration.

### DETAILED DESCRIPTION

The present disclosure describes aspects of embodiments of a system and method for stimulating and enacting commerce using native virtual currency, rewards and transaction enablement. More specifically, the system and method encourages and facilitates transaction with and amongst members, it's incentive loop aspect provides value to advertisers as well as purchasers.

The present invention is described in detail herein. In an embodiment of the invention enrolled parties, members (sometimes herein called “users”, “parties” or “member transactors”) receive distributions of native virtual currency from the system. Members may also come into possession of native virtual currency in transactions with other members, transactions in a preferred embodiment such as purchase and sale transactions, gifting transactions and other transaction types such as reimbursement transactions where brands exchange money or value with vendors receiving native virtual currency in brand-sponsored transactions.

Native virtual currency is accepted by the system from members purchasing the system's commerce promulgation services, for example purchasing advertising from the system. In a preferred embodiment purchase and sale transactions between members may comprise a “mix” of a native virtual currency and “real” money, or solely either. As well, the system accepts a mix, as will be further described below. When a native currency is included in part of the payment the term “mix” or “mixed” will be utilized herein, and also sometimes “proportional” or “proportions”.

Virtual currency has been around for a long while, and since the popular arrival of the Internet virtual currencies appeared in online games, rewards and loyalty schemes, redemption schemes, trading schemes, pegged commodity schemes and other implementations. And most recently a virtual currency cryptocurrency has been introduced upon the world, Bitcoin. The present invention utilizes virtual currency, one that it restricts in usage to within the system, to make this clear I use herein the term “native virtual currency” for currency distributed by the system to members, received by the system from members and exchanged amongst members.

The invention's deployment of native virtual currency, an important aspect, is noteworthy, native virtual currency a lifeblood, it helps transactions that may otherwise have not been performed. Distributing it, circulating it and effectively reabsorbing it where it may be distributed yet again anew at the heart of the system's virtue. Without the circulatory loop the system would be no better than the prior art.

Native virtual currency is fully electronic, meaning changes in ownership are realized via bookkeeping entries. Bookkeeping may be performed and or stored centrally, as is familiar in general in banking and most business. Alternatively or on conjunction with a centralized schema a peer-to-peer architecture could be utilized where the “books” are electronically and cryptographically stored as, for example the Bitcoin architecture has taught. The system is agnostic as to the type of bookkeeping utilized. For example, should ever biological methods for bookkeeping be invented, wherein for example peoples DNA is encoded with transaction records, such a system could be adapted to function to support the bookkeeping requirements so long as records are writable, readable, durable and not subject to hazards.

A preferred embodiment of the present invention interacts with members' “virtual wallets” or “e-wallets”, herein referred to as “wallets” or “wallet apps”, meaning software that run on electronic computing devices used for transacting. Wallets may also be hardware, though more typical today are software applications running on electronic devices such as smartphones, tablets and notebook and desktop computers. Wallets, familiar art, are but one means to interact with the system, wallet functionality may also be achieved via web pages, also familiar art, as banking and accounting services provide. Wallets in some peer-to-peer schemes also contain the “books” for the wallet owner and possible others in encrypted form, the books means transactions and or balances controlled by the user.

Wallet acceptance on the part of transactors appear to presently be encountering a good bit of resistance, at the time of the filing of this disclosure a major Internet search giant appears to be encountering push back in it's attempts to acquire wallet users. The invention, with it's novel approach to promulgating and enabling commerce both online and in the physical world, and other aspects of the invention, improves the desirability of having a wallet app, an app where aspects of the invention benefit the wallet user.

Along the spectrum of good surprises, receiving something of value is generally perceived as a good thing. When one receives something expected, for example flyer miles when purchasing an airline ticket, it's thought by the recipient generally not to be a bad thing, but it's not a surprise so the “surprise value” is lost. Unexpected from an airline is a free first class upgrade, a surprise having value. When a nice price reduction coupon is received, for example a price reduction on a desired electronic device, for example a luxe smartphone, it is also generally well received, particularly when the receiving is a surprise. When a particular behavior is associated in a recipient's—or an observer of a recipient—thinking with a trigger for the distribution and receipt of a surprise, it may not be unreasonable to expect the recipient and or observer to perform or adopt said behavior. Those skilled in the art are familiar with reinforcement methods, for example those used to encourage weight loss, quitting smoking and other actions that many consider beneficial. receiving native virtual currency is not totally dissimilar to receiving said nice price reduction coupon, when the outcome is the purchase of said luxe electronic device and a beneficial price native virtual currency is in effect a wonderful discount.

The Internet giants, for example the large search companies, social networks, high volume book and goods vendors, advertising distribution networks and other types of companies, spend and invest rather huge sums, sometimes in the billions of dollars on developing or acquiring methods and systems for engaging new customers and maintaining their existing membership. As much as the Internet giants and others have tried, none has disclosed a looped incentive commerce system as disclosed herein. The present invention may be constructed by any skilled in the art, the combined aspects of the present invention overcome problems not resolved by prior art.

In this description, reference will be made to the appended drawings, in which:

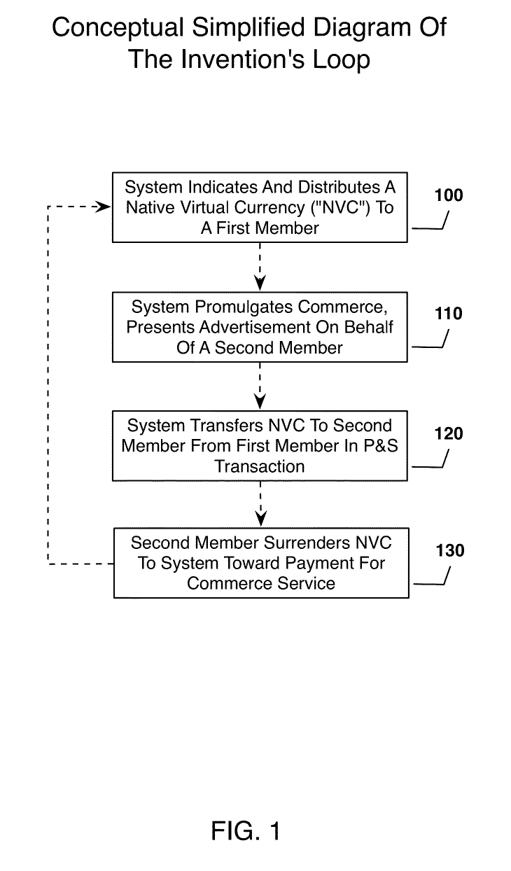

FIG. 1 introduces the concept of the invention's commerce loop. In the preferred embodiment the loop includes more transactions before the native virtual currency wends it way back to the system, stimulating further commerce along the way. When the system absorbs native virtual currency it does not do so by exchanging it for real money, it is always in a preferred embodiment accepted in full or partial payment for promulgating commerce, for example delivering an advertisement on behalf of a member. Reabsorbing native virtual currency in exchange for services is an important aspect of the invention. It both provides discounts for members as well as helps manage the amount and circulation of native virtual currency in the system, as does distributions and does the effectiveness of promulgating advertising.

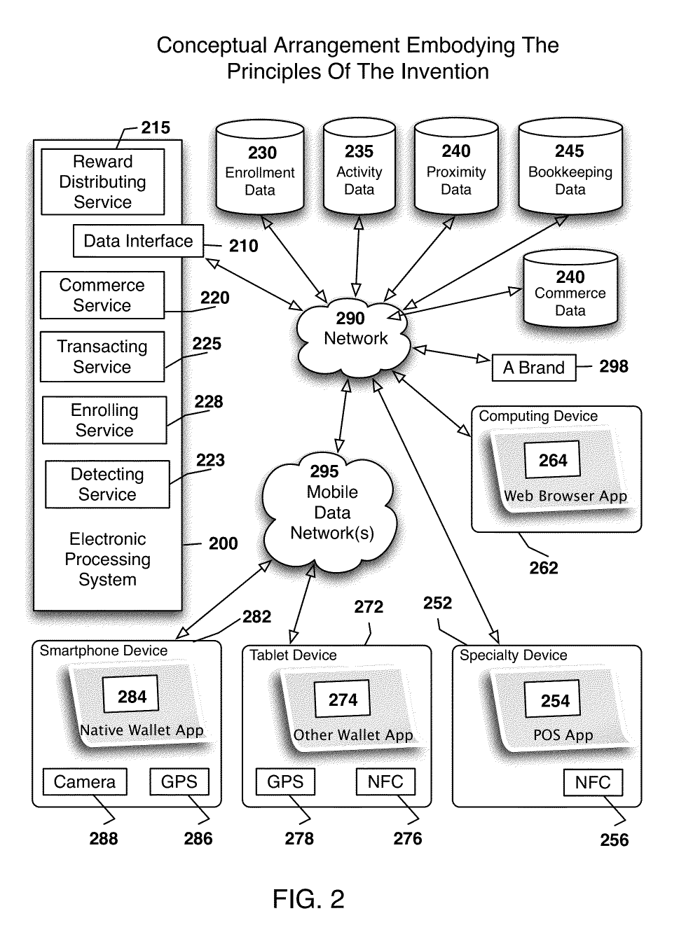

FIG. 2 shows a conceptual arrangement embodying the principals of the invention. In the preferred embodiment the system's services programmatically run on an electronic processing system 200 coupled by a data interface 210 to one or more networks, for example the Internet and mobile data networks. Any or all of virtual wallet apps 284; 274, point of sale (“POS”) apps 254 and web browsers 264 utilizes the system's services. Such apps run on Smartphone devices 282, tablet devices 272, specialty devices 252 and other computing devices 262, for example notebook computers, desktop computers, netbook computers and other electronic devices. In the course of commerce promulgation 110 on behalf of members, distributions 100 to members, transactions 120 amongst members, compensation 100 from members for commerce promulgation services, delivering information to and or exchanging information members, the system, in a preferred embodiment, communicates with members and databases. In addition to the system's own program apps utilize the system's services 215; 220; 225; 225; 223. From the perspective of an app the system is a platform for conducting commerce, in the same way, very generally, as an email app sees an email system, an advertising app sees an advertising platform or music app sees a music server in the cloud.

In an alternative embodiment devices and software, for example cameras, facial detection software, RFID and other types of detectors, token collectors, card readers, checkpoint readers, loggers, brainwave signal receiver, receivers and biometric sensors also communicate with the system's services, for example to detect and or report member proximity to the system and collect further data.

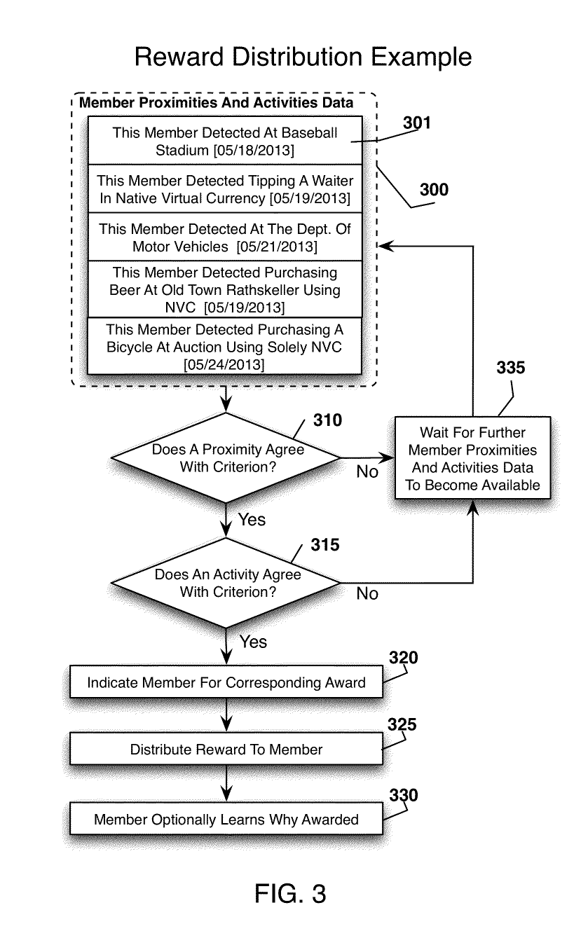

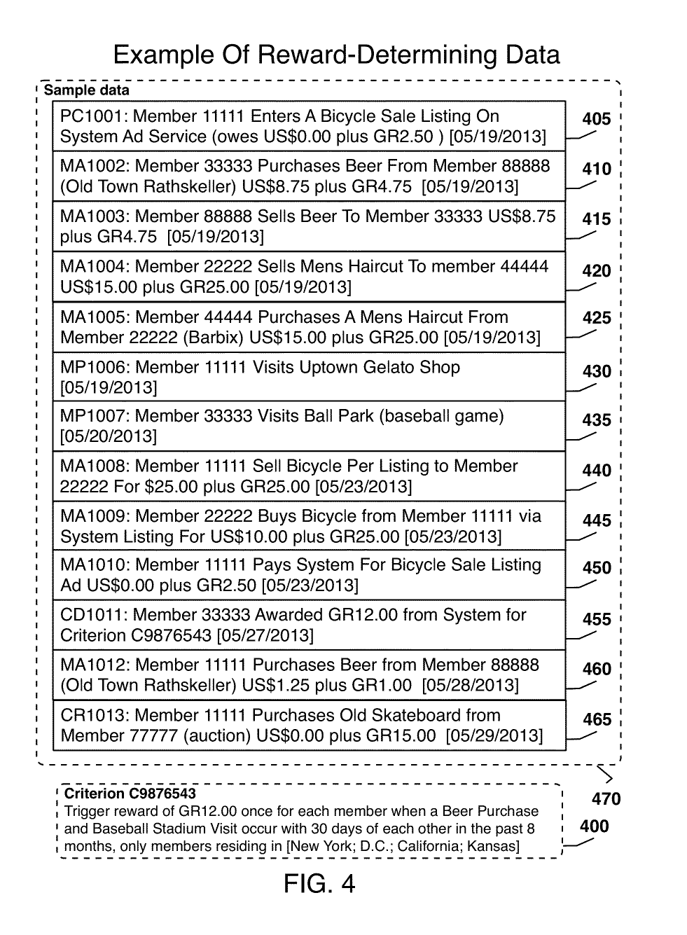

According to aspects of embodiments of the disclosed subject matter herein and arrangements embodying principles of the system, the method and system accesses databases comprising information relating to members. In the preferred embodiment member activity and member proximity data is detected by a detecting service 223. Member activity data, means transactional data, illustrative examples of such data are interspersed in FIG. 3 300 and FIG. 4 470. Member proximity data, means locational nearness, illustrative examples of such data are also interspersed in FIG. 3 300 and FIG. 4 470. Activity data and proximity data resources my be wallet apps, for example one that can capture geographic coordinates data from a smartphone's GPS radio 278; 286, feeds or file transfers from banks and other financial services companies, for example credit card or accounting businesses and or further sources. Enrollment data 230 may be collected by the enrollment service 228, for example when a member voluntarily “joins” and or detected 223 from one or more databases, for example databases of a partner financial services company, mobile telephone company, agency. In a preferred embodiment enrollment is performed via a sign-up page in a wallet app 284; 274, on a web page in a web browser 264, or in a page in a point of sale app 254, or via other electronic data entry methods.

FIG. 3 shows an example for how an arrangement of the invention indicates a reward 320 for a member and distributes said reward 235 as well as optionally enables the member to learn 330 some or all of the reasoning the reward was distributed. Learning reasoning is potentially a behavioral assistance tool for encouraging members to extrapolate for future rewards, generally, activities and proximities that might be good for helping in receiving pleasantly surprising rewards. For example, if tipping waiters using native virtual currency frequently triggers a reward the member might do more of it. When a member's proximity and activity data 300 does not satisfy both the proximity test 310 and activity test 315 the system awaits further data 335, at which point it again attempts to determine if the member is due a reward. For example, new activity data may arrive comprising the fact that this member tipped a waiter on May 25, 2013, said new activity data may satisfy the activity criterion 315 where the proximity criterion is satisfied 310 by having been detected in a baseball stadium 301 on May 18, 2013, the criterion may have included a requirement that the occurrence of both the ball park proximity and the tipping activity be within 30 days of each other, as it is in this example.

FIG. 4 shows an example of reward-determining data 470, including an example of how a criterion 440, expressed in plain English, may appear. The example in FIG. 300 shows data for one hypothetical member, FIG. 4 shows data for several hypothetical members. This example helps visualize what the system accomplishes—promulgating and stimulating commerce utilizing an incentive loop. For example, commerce is specifically promulgated on behalf of member 11111 via an advertisement 405 for a bicycle, said member compensating the system for said advertisement 450 in this example using solely native virtual currency. Said payment in other example may be in a mix of real money plus native virtual currency. Data in any of the exemplary records 405; 410; 415; 420; 425; 430; 435; 440; 445; 450; 455; 460; 465 could contribute triggering a reward.

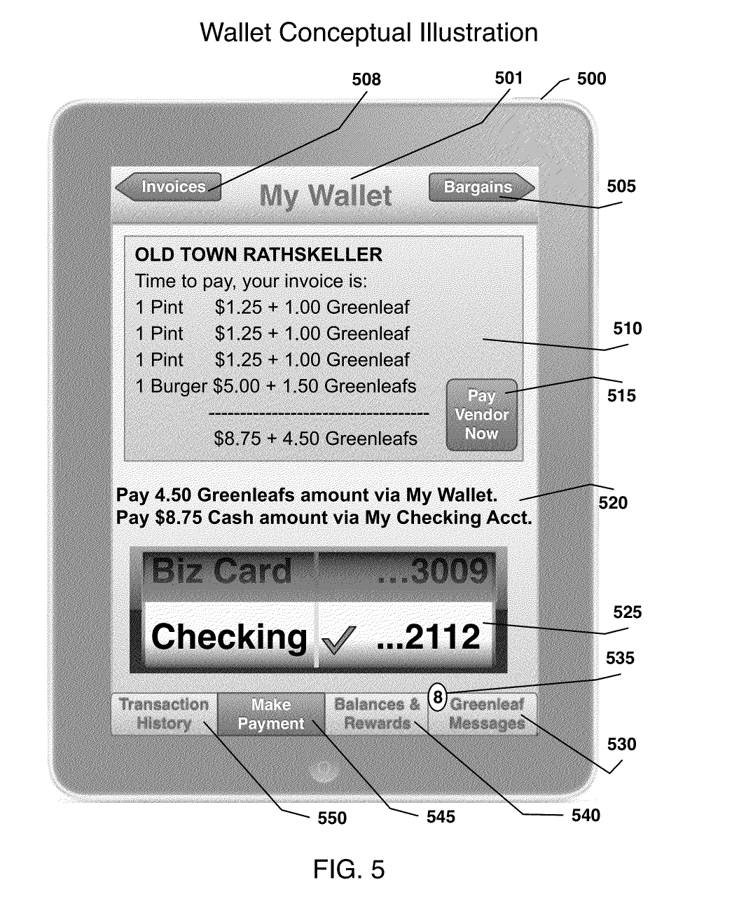

FIG. 5. is a conceptual illustration of a member's wallet app 501 running on a portable computing device 500, a tablet device, connected to the Internet. On one example the member's wallet app, let's identify the member as Member 88888, is about to pay his invoice (sometimes also known as a “check” or “bill”) at a gastropub. Said invoice presents the amount owed, it is mixed, Member 88888 owes US$8.75 and 4.50 Greenleafs 510, a Greenleaf being the moniker of a native virtual currency for this example. Returning to FIG. 4 briefly, a corresponding exemplary record 415 showing Member 88888 pays a further Member 33333, the gastropub Old Town Rathskeller. A further record shows Member 33333 is shown receiving said payment 410. In a preferred embodiment a wallet app is somewhat functionally similar to the illustration FIG. 4, design also may be similar or different according to local tastes and language preferences. The wallet in this illustration gives members access to their transaction history 550, a tab 545 comprising an interface to view invoices 508 including an interface that for making payments; 510; 515; 520; 525, a tab enabling viewing the member's account and rewards balances 540, a tab for interacting with messages 535 from the system and other users which may include enticements to transact was well as “hints narratives” (disclosed later, herein) which may enhance the possibility of receiving a reward and a visible indicator 550 to alert users when they have unread message, as well as a access to an interface for viewing and search for “bargains” 505. “Bargains” herein mean transactions proffered and delivered on behalf of members and commerce services provided by the system.

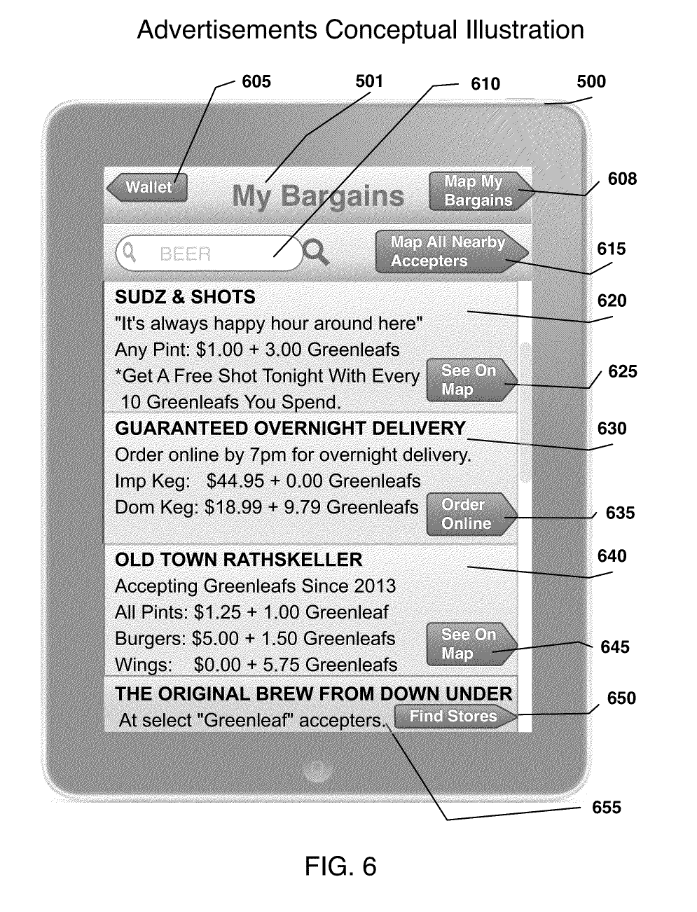

FIG. 6 is a conceptual illustration of a bargain interface 501 of a wallet app, the main wallet interface quickly accessible 605. The displayed bargains may be targeted to the member based upon characterizations of member action and or proximity data and or volunteered data, for example a “wish-list” of favored brands or shops. The system's services provide data to and receive data from wallet apps. In a preferred embodiment advertiser's geographic coordinates are utilized for mapping 608 as well as for search query results 615. In a preferred embodiment bargains for online shopping comprise links to websites, when a user “visits” a website that visit becomes proximity data for said member.

Having disclosed above in illustrations, concepts and examples how the present invention operates, an understanding of the present invention's uniqueness in how it stimulates commerce utilizing its incentive loop. Loops in general are not new. What is new is how the invention, in essence, facilitates pumping transactions along the loop, itself at both the start and finish, itself vending to members services in exchange for native virtual currency, native virtual currency each may utilize in their own transactions with members, native virtual currency which is distributed to member, where distributions are not in exchange for payment from a member or for a member performing directed work.

The preferred embodiment includes utilizing two criterion, activity and proximity, for determining if a distribution is triggered claim 5 a member. In an alternative embodiment the criteria may be simpler or more complex.

In an alternative embodiment members could of bargains on a webpage and transact using web browsers, instead of wallet apps. Smartphones are not utilized. Purchases and sales transactions amongst parties, for example a first party selling a bicycle to a second party are performed with both parties utilizing a single desktop computing device, each logged into their respective account in the system, independent of whether the seller advertised or not the bicycle to the purchasing member.

In a preferred embodiment members transacting with online stores are identified for invoice payment on a checkout page for member shoppers without having to log in on the checkout page. An encoded graphic is captured by the member's smartphone wallet app, for example a QR code. Said graphic is decoded and utilized to learn the session ID and store ID of said checkout page. The session ID is utilized by the transacting service 225 to retrieve an invoice from the store associated with said store ID, and present it to said member shopper in the invoices section 508 of his smartphone wallet for member approval in the make payment tab 545 by actuating a “Pay Vendor Now” button 515. Upon actuation the transacting service 225 is instructed to processes the transaction whereupon the transaction is processes and the store's checkout server is notified of transactions completion, then refreshing the checkout page indicating to the member shopper the invoice is paid. In parallel, the member's wallet's transaction history 550 is updated. In an alternative embodiment OAuth could be utilized to identify the member for checkout for transactions requiring payment in a native virtual currency.

Continuing and returning to a preferred embodiment, members transacting with members, for example a party selling a used bicycle to a neighbor, may transact may find it beneficial to accept native virtual currency for a portion of the payment. In such a mixed payment example, the party receiving the native virtual currency may have had a strong motive in accepting native virtual currency, for example the need for a commerce promulgating service for which the system accepts only native virtual currency.

In a preferred embodiment, one or more mobile data networks 295 connect members' smartphone devices, smartphones having GPS radios 286; 278 built in, with the system's services. Other computing devices besides smartphones, for example desktop computers and notebook computers 252 and 262 may also be utilized by members in the preferred embodiment. A network such as the Internet 290 or one or more other networks may connect a mobile data network to the system, or a mobile data network could be connected directly to a data interface 210 to connect to the program facilitating the system. Also in the preferred embodiment members' smartphones have cameras 288 for capturing images, which may capture images for proving, or proxying, online or physical world proximity or utilized for capturing an encoded graphic. Near field communication 256; 276 capabilities, while not necessary, are desirable, as persons skilled in the art are familiar, for identity learning and proximity learning purposes.

Regarding the system's services, a reward distribution service 215, a commerce service 220, a transacting service 225, an enrollment service 228 and a detecting service 223 are individualized in the conceptual arrangement illustration FIG. 2, those skilled in the art will recognize such services may be implemented programmatically together as a unified service or in various permutations and combinations. Equally, databases may be structured and distributed in any manner, whether relational, non-relations noSQL, combined or other scheme, those skilled in the art may architect the data structure or structures in accordance with response time goals and other objectives. The drawings, illustrations, example and step utilized for teaching the invention should not be read as the only way to construct and or configure the invention. Exploring each service individually further enables persons skilled in the art to make and use the invention.

A transacting service 225 generally also performs bookkeeping during a transaction. Interestingly, in a peer-to-peer arrange the functionality of this service may distributed, for example built in wallet apps. Whether centralized or distributed architecture it choses, or perhaps both, ensuring sellers are credited for native virtual currency and purchasers are debited for native virtual currency when transacting is performed is necessary, updating bookkeeping data store(s) 245 generally must reflect transactions sufficiently to provide the data necessary for performing distributions, promulgating commerce, enabling transacting and accepting payment.

A reward distributing service 215 generally performs rewards related functionality, for example handling criteria, determining if a reward should be distributed and reward size, notifying members, updating a centralized or distributed database 245 to reflect the transactions.

A commerce service 220 generally performs and manages commerce promulgating functionality, for example accepting and delivering ads, receiving payment for ads and other commerce promulgation services, accessing commerce database 222.

An enrollment service 228 generally handles member enrollment and profiles, for example member authentication for wallet app access and member web access, accessing enrollment database 230.

An detecting service 223 generally accesses feeds, databases and other resources for the system to learn of member proximity and activity, for example if a user has been in a ballpark or a pub, has purchased beer and or specific brand of beer, donated to a charity or a specific charity, tipped a hospitality worker, sold three hours of coding service, held an average balance in a banking account for a determined period and other such proximity and action data, as illustrated conceptually by an activity database 235 and a proximity database 240.

Further continuing with a preferred embodiment and examples, in the bicycle seller example FIG. 4 we briefly visited earlier we now shall delve into more detail. Let's assume the transaction had a non-native virtual currency component of US$10.00 and native virtual currency component of 25.00 units, we'll again refer a native virtual currency by a made up moniker—“Greenleafs”—in this example. The seller now having a further 25.00 Greenleafs in her account pays the system for the commerce promulgating service 110, the advertisement she placed for the bicycle. The system in this example charges 2.50 Greenleafs for a bicycle advertisement. In this example is no US$ amount for bicycle ads, though for other services, for example selling a haircut there could be both a native virtual currency amount and a US$ amount. In the preferred embodiment the system may be configured to only accept a specific mix or leave it up to the payer to decide the mix, for example the system may proffer delivering an ad for US$1.00 and 2.00 Greenleafs, or is may command 2.50 Greenleafs and no dollars, or it may command US$3.00, leaving it up to the advertiser to decide which to choose.

In the preferred embodiment mix and mix unit amount determination may be proffered as a choice of mixes and amounts for counter-parties to have and make selection or it may be a take-it-or-leave-it proposition. For example, a seller may proffer that a buyer has the choice of bargains, paying 50.00 Greenleafs, or paying 25.00 Greenleafs plus 25.00 dollars or paying 52.00 dollars. Similarly the seller may proffer only one bargain, for example at least 45.00 dollars plus to-be-determined Greenleafs, meaning the seller is inviting a negotiation with a firm base dollar amount. Further, the seller may proffer a single bargain scenario, $40.00 plus 7.50 Greenleafs. Another single bargain scenario might be 75.00 Greenleafs. in the preferred embodiment the system prices it's commerce promulgating services with similar flexibility.

Understanding now how the invention operates and by one skilled in the art the ways in which the invention may be built let's have a closer look at how and why in the preferred embodiment vendors have an incentive to be members of the system. Distributions of native virtual currency are different from other popular incentives, let's first look back in the art at rewards given by vendors based upon a purchase requirement. Rewards tied to purchase requirements, such as coupons for “dollars off” in a future purchase may be worked out to be economic for some vendors. Similarly, loyalty cards bring back purchasers a specified number of times, coffee shops tend to like such schemes because the discount is pushed of into the future. Both of these schemes do indeed provide discounts benefitting the customers and further business for the vendor however the vendor suffers the discount, in the next transaction or when the loyalty card reaches it reward point. The invention, on the other hand, puts in the hands of the vendor an amount of native virtual currency in exchange for the discount. And this happens at the point of the first transaction, the vendor actually receives something of value, something that can be used to further promulgate on the vendor's behalf—purchase advertising or other commerce services from the system, or receive discounted prices from other members of the system, for example a supplier to their business. A gelato shop accepting virtual currency may pay it's milk supplier in part, for example, using virtual currency, the milk supplier may pay the garage who maintains it's trucks using virtual currency, who may then purchase an advertisement with the system using virtual currency announcing they are hiring mechanics.

In an alternative embodiment the system may offer more complex transactions, ones that enable a brand to drive sales to vendors utilizing native virtual currency. Such a transaction could be thought of a s a refunding transactions because the native virtual currency received by the vendor during a brand's promotion campaign is automatically purchased by the brand leaving the vendor whole in real money and or additional goods from said brand. in such configuration the system prompts a reimbursement transaction, for example for a transfer of a specified amount of US$ per unit of native virtual currency in exchange or that amount of native virtual currency being transferred to the brand from the vender, which is similarly caused by the system. It is generally thought disadvantageous for vendors to accept brand coupons at checkout, the manual labor alone is enough for vendors to dislike coupons. And today, in the art when coupons are automated it still requires the vendor the swipe a card or type a code into a data collection device, then confirm a response code, and sometimes enter that code manually again or print a hard copy record. The invention obviates this rather complicated inconvenience by initiating automatically the exchange of the native virtual currency received by the vendor for a real money, in this example United States dollars. Easily, value other that US$ could be configured into the second transaction, for example it could create an instruction to the brand to deliver specific merchandise of equivalent value to the native virtual currency surrendered in the second transaction. Such configuration is also useful for transactions where vendors make donations “with each purchase”.

Returning to FIG. 2 and FIG. 3, let us traverse the distribution process again from beginning to end with a further example. A member's proximity and activity data 300 is detected 223, in this example the member is detected at a ballpark 301 which may have been learned by the system using facial recognition of a photo in a timeline on a social network account. Of course it needn't have been facial recognition from a photo, it could have been detecting the member using a key card or fob to prove his identity when entering the ballpark or selecting a seat, or even fingerprint or retina recognition, DNA recognition or other biometric identifying methods. The system is agnostic as to the method and the resource the system builder chooses, just so long as detection is operable. In the case of activity data, feeds and or connections to financial services records are generally the resource, though cash transactions may be captured manually or for example by capturing a code from a cash purchase receipt, banking or automated teller receipt or other capture method. When a member's proximity data agrees with a criterion 310 and the member's activity data agrees with a criterion 315 the member is deemed by a reward distribution service 215 as being due the reward, said service credits the reward to the member, a bookkeeping entry. The reward may be an exact amount of a native virtual currency as specified within the criterion or otherwise linked to the criterion or it may be a calculated amount of native virtual currency, the invention may be configured for either or both methods.

In a further example, criteria may deem a reward is due for distribution to a member meeting a banking and a “house or worship” criteria, for example the activity criterion being a member having maintained a minimum average monetary balance for 10 days in an account known to the member's virtual wallet and for also meeting the criterion of having been detected in a house of worship thrice within the past 365 days. The native virtual currency could be a fixed amount, for example 3.00 Greenleafs or be a function of the average balance, calculated similarly perhaps to how interest on a real money deposit in a bank is performed.

An important aspect of the invention is that criteria may be different for different groups or individual members claim 8. For example, the banking/worshiping criteria in the example above may have been deployed for a specific or algorithmically specified subset of members, the subset possibly as small as just one member.

Another important aspect of the invention is the system may be configured for reward indication schemes other than the activity/proximity model utilized in this disclosure.

The activity/proximity model disclosed herein is also the subject matter of my co-pending patent application filed of even date herewith entitled “Electronic Reward System”. The invention also allows for configuring other methods and systems for determining distributions, according to the present inventions distributing step claim 1 (ii) and trigger claim 5.

Observing now at a larger example of a member data sampling, this time not the data for just one member as in FIG. 3 but for multiple members FIG. 4 with a similar criterion 400, again, as used in the bicycle example above. Said sample data 470 illustrates transactions using both native virtual currency and other currencies such as the real money, United States dollars. In a preferred embodiment the data for each record is more exhaustive, the brevity of the record field content and record quantity is utilized to make it easy to follow an example without introducing the technicalities those familiar with art use in implementing database designs and architecture. Each entry, for example entry 405, includes, in this conceptual record example, includes a record identifier and embedded type identifier, in this entry the identifier is PC1001, PC meaning “promulgating commerce”. Such identifiers are only, for example, the system may be implemented with any record scheme one skilled in the art deems appropriate. MA is utilized in this sample meaning “member activity”, MP meaning “member proximity”, CD meaning “native virtual currency distribution”, and CR meaning “native virtual currency reabsorption”. GR is used in this example to denote “Greenleafs”, “US$” denotes United States dollars. The system promulgates commerce for member 11111 by accepting an ad listing 405 for a bicycle for sale to be displayed to members. In the preferred embodiment the ad may be targeted, it is displayed by the system to one or more members. The ad may also be made available to content publishers for display elsewhere.

The barber 420 who received payment in native virtual currency and then uses it towards the purchase of a bicycle 445, perhaps in conjunction with native virtual currency accumulated from distributions or accepted in other purchase and sale transactions and gratuity transactions, has helped the bicycle seller 440 who pays for the advertising assist from the system 450 in native virtual currency. The parties all benefit, they obtain the good and services they want even though none may have had sufficient real money to achieve their goals.

The problem of sluggish local, national, or global for that matter, economy may be eased by the invention. Stimulating commerce is an object of the invention. Looking at native virtual currency as a “lubricant” for any type of transaction we come to understand how the invention is generally stimulative whilst immediately benefitting members in every transaction. The invention may cause advertising to be thought of by advertisers and members alike as more beneficial than display ads. Hint narratives claim 15 (e) are an aspect of the invention that encourages members to be attentive to the system whilst not cramming disturbing advertisement boxes and popups on their smartphone screens with pinhead-sized close buttons even too small for a baby's finger to operate. Attention hogging and attention diverting are two problems the invention solves, when all interactions are rewarding or potentially rewarding advertisers enter a new relationship with customers and prospects.

The illustrated virtual wallet 500 is, in another example, operated by a financial institution. The member's wallet app shows him how much he has consumed and how much he owes 510, his bill. His unpaid bill appears in the wallet's “Make Payments” tab 545, where other unpaid invoices and mills may appear. Having selected 525 to use his checking account to pay the real money portion of the bill he may actuate the “Pay Vendor Now” button to cause the wallet to notify the system's program running on the electronic system processor 200 to engage the transacting service 225. Depending upon the configuration, either the wallet or the transactions service can prompt the real money portion of the transaction, for example initiating a clearinghouse transaction wherein United States dollars are debited from the member's checking account and credited to the merchant's account, which may be at the same or a different financial institution.

Wallets, as is familiar in the art, need to “know” who the counter-party is so that bills and invoices are delivered to the correct wallet and payment is transaction to the correct accounts. Many techniques for wallet “pairing” exist, ranging from near field communication methods, GPS methods, capturing an encoded graphic for the screen of on with the camera of the other, manually typing in exchanged codes retrieved from each other's displays and other methods. In the preferred embodiment the system, by virtue of each wallet being recognized by the system by each's unique ID or other method, permits the member to choose how they pair in a transaction. Popular pairing methods in the art already are “bumping” where, first, user location is sensed and reported, usually GPS coordinates, though other coordinates systems are utilized in other methods, or other location identification means are known be proximate to each other and, secondly, accelerometers in each's smartphone are jarred together during said bump and the temporality of said jarring is reported used to affirm the pair. Other common pairing methods rely on the same first location information, then, second, a verbal queue, for example a voluntary oral first name exchange and then a third confirmation, for example the visual comparison of one or both parties' facial images displayed on each other's screens delivered to the members based upon the first and second data, with their actual face. Another method is near field communication, which may be the easiest. The invention is agnostic as to how wallets are paired, it may be built and operated for any such scheme known today or invented in the future.

In the case of online purchases the smartphone user's wallet app may simply capture with its camera an encoded graphic, for example a single use QR code, generated by the vendors shopping cart program presented on the screen of a second computing device such as a desktop computer, which then is used to pair wallet in the smartphone with the shopping cart transaction of the online vendor. This of course will not work when the shopping is occurring on the smartphone itself, in which case other paring methods are known in the art and available. In the preferred embodiment the shopping session occurs in a browser within the wallet, making it relatively easy to perform the pairing. Again, the system is agnostic as to how the pairing occurs, the system only needs to know who the parties are and such methodology and functionality is known to those skilled in the art.

In the preferred embodiment the user may receive messages from the system, one method is these messages arrive in a mailbox within a wallet 530. An unread message indicator 535 displays when the member has received a distributions, a bargain type for which the member has generally indicated interest, bargain negotiations and other message types. The also may make it easy for a member to learn account balances and rewards balances 540, for example how much of a native virtual currency the member controls. Learning transaction history 550 from a wallet may also be beneficial to the member. So for example, learning one has a substantial or unexpectedly endowed native virtual currency balance may encourage seeking bargains 505.

An exemplary illustration for how an ad may be displayed 640 in a “Bargains” tab 601 of a wallet app, this one for a hypothetical gastropub, Old Town Rathskeller, appears because the member filtered 610 using the keyword “beer”. A wallet's bargains tab may be valuable to members. The system ad may have been placed by the advertiser using a browser 264, in the preferred embodiment a tab in a wallet app also is a means for the system to accept and advertisement from a member, as would be a tab in a point of sale app 254.

It's been mentioned before herein and worth stating very specifically, the system may handle more than one native virtual currency claim 1 (ii) and each may be identified by its own moniker as we did in the Greenleaf example. Also, the value of a native virtual currency may vary, claim 3, not only over time but across transactions, not all transaction occurring at the same moment may imply an equal value to an equal amount of the same native virtual currency. Also, the commerce service 220 may store members' bargain search enquiries, and utilize these separately or in conjunction with the member's activity and or proximity data to target advertising.

A type of transaction we haven't spoken about yet is the gifting transaction, for example giving a hospitality worker such as a waiter member a tip in native virtual currency. Pairing again comes into play, particularly when the waiter does not carry a smartphone. And again, the system is agnostic as to how the pairing occurs, the system only needs to know the identity of both members, which for the tipping member is easy, for the waiter's identity is may be more difficult to obtains. There are several means to obtain the waiter's identity. For example, a unique encoded “thank you code” graphic could be printed on a name badge of the waiter, an example of such a code is a QR code. In the preferred embodiment the tipping member's wallet app has functionality to not only capture the QR code and send it to the system for pairing but also to then display an image from the system's enrollment database 230 for confirmation, whereupon the tipper selects a tip amount and actuates a “Give Gratuity” button in the wallet interface. The tipper also has the choice of remaining anonymous or disclosing his identity to the waiter.

Receiving native virtual currency electronically distributions may be a welcome surprise to members, generally it's nice to receive a good surprise. In a preferred embodiment members utilize wallet apps for transacting and discovering bargains as well as sending coordinates data to the system for proximity characterization. A wallet app configured to alert the member with a message when distributions are received is preferred. Other messages may accompany distributions, for example disclosure of a bargain proffered by a nearby shop or online. Within the wallet app bargain searching 505 in merely a tab or so away. The invention's system, a platform that supports virtual wallet apps, POS systems as well as interaction via Internet browsers, enables a new means for stimulating commerce and transacting it. Plus it provides value for members in distributions that they do not pay for, though they may earn it in transactions such as selling, working or be the fortunate recipient of a gratuity from another member. For sellers and other advertisers the system promulgates commerce and does so innovatively by enabling sellers to recover some or all, and perhaps more, of the value given the purchases in a discounted offer, as well as perhaps attract transactions the seller might not have otherwise enjoyed, transactions with buyers who tend toward purchasing at the lowest price possible, sometimes referred to a value hunters.

In alternative embodiments compensation is received for services other than commerce promulgation services, as well as goods and property.

The invention solves the problem of attracting value hunters without creating the visual to full price payers that a seller is a discounter. It also solves the loss sellers experience giving purchasers traditional discounts. Notable, it solves the problem of users feeling “lost at sea” when using a virtual currency, native virtual currency combined with accepting payments from members for services in full or in part in native virtual currency helps everyone in the system “anchor” their intuitions regarding the value of a unit of a native virtual currency. Moreover, by distributing native virtual currency to members neither in exchange for real money nor for performing directed work the system enables members who may not have had sufficient real money to transact to make purchases, a virtual money distribution may feel to the recipient like a blessing.

The above description and the drawings are merely intended for use as explanation of the invention and must by no means be construed as being limitative to the scope of the invention. All of the foregoing merely illustrates the principles of the invention and numerous alternatives are possible. Some sequences of steps presented should be understood to not limit the invention to that same sequence, the invention may be built and operated with other sequences and or by combining steps or splitting steps into further steps than those shown herein. The specification and drawings are, accordingly, to be regarded in an illustrative sense for explanation of aspects of the disclosed subject matter rather than a restrictive or limiting sense. Practitioners will appreciate that there are a number of ways to implement the principles of the invention using various alternative arrangements not explicitly shown or described herein while still being within the invention's spirit and scope.

1. A method performed by a computer system, the method comprising: electronically
(i) promulgating commerce on behalf of at least one promoter member,
(ii) electronically distributing at least one native virtual currency to system members on behalf of the system,
(iii) enabling transacting amongst system members using said native virtual currency, and
(iv) accepting compensation in said native virtual currency from said at least one promoter member for promulgating commerce per step (i).

2. The method of claim 1 wherein native virtual currency means a virtual currency, scrip, note, digital currency or other value whose use is limited by the system to transactions among the member transactors.

3. The method of claim 1 wherein the per unit value of a native virtual currency for at least one member varies.

4. The method of claim 1 wherein the per unit value of a native virtual currency at least one member is fixed.

5. The method of claim 1 wherein the distributing of step (ii) is performed without the native virtual currency being exchanged for fiat money or non-native virtual currency from the receiving member, fiat money being legal tender that derives its value from government regulation or law.

6. The method of claim 1 wherein in the distributing step (ii) includes at least one awarding trigger.

7. The method of claim 5 wherein said trigger does not include the receiving member completing a directed purchase transaction in exchange for receiving the distribution when a promoter member selecting or specifying all criterion for said awarding trigger and said promoter member is the beneficiary of said directed purchase transaction.

8. The method of claim 5 wherein said trigger does not include performance of directed work by said receiving member in exchange for receiving the distribution when said promoter member is the beneficiary of said directed work, directed work being providing to said promoter member personal information, providing to said promoter member the receiving member's opinion or being instructed by said promoter member to for a period of time be exposed to marketing propaganda or said promoter member.

9. The method of claim 5 wherein a said trigger may be applicable to a subset of members, said subset as small as one member.

10. The method of claim 1 wherein in step (iv) accepting compensation in said native virtual currency is for the full amount of or a partial amount towards a due payment.

11. The method of claim 1 wherein in step (iv) said at least one promoter member received said native virtual currency in the course of transacting with another system member.

12. The method of claim 1 wherein in step (iv) said at least one promoter member received said native virtual currency in a distribution.

13. The method of claim 1 wherein the enabling transacting step (iii) may include enabling at least one member to borrow virtual native currency and or lend virtual native currency.

14. The method of claim 1 wherein the enabling transacting of step (iii) may be interface with at least one processing-related party.

15. The method of claim 1 wherein said promulgating commerce of step (i) includes at least one of a) enabling system members to learn of the membership of other members, b) making at least system members aware that said at least one promoter member will accept a native virtual currency, c) distributing advertising on behalf of said at least one promoter member, d) publishing to at least one member on behalf of said at least one promoter member, e) revealing to at least one member some or all of a hint narrative on behalf of said at least one promoter member, or f) providing business and or financial services to users.

16. An electronic processing system including one or more processors and adapted to execute programming that, electronically,
(i) promulgates commerce on behalf of at least one promoter member,
(ii) electronically distributes at least one native virtual currency to system members on behalf of the system,
(iii) enables transacting amongst system members using said native virtual currency, and
(iv) accepts compensation in said native virtual currency from said at least one promoter member for promulgating commerce per step (i).
